(19) United States
(12) Patent Application Publication
(10) Pub. No.: US 2001/0032410 A1
(43) Pub. Date: Oct. 25, 2001

(54) Fishing rod holder for bank and coastal fishing

(76) Inventor: Larry Alan Hayes, Shepherd, TX (US)

Correspondence Address: Larry A. Hayes, 2910 Highway 59 North, Shepherd, TX, 77371, US

(21) Appl. No.: 09/785,120

(22) Filed: Feb. 16, 2001

Related U.S. Application Data
(60) Provisional application No. 60/184,124, filed on Feb. 22, 2000.

(51) Int. Cl. A01K 97/10

(52) U.S. Cl. 43/21.2

(57) ABSTRACT

A Fishing Rod Holder for Bank and Coastal Fishing consisting of a 3-4 foot rigid rod secured with plastic tie wraps and adhesive to a rigid tube, the ends of which have been cut at parallel angles. The said rod, being of rigid material and extending to top of rod holder, can be hammered into hard ground. The said tube, being of sufficient inside diameter, accommodates all rod handles, even pistol grip. Angled cut of bottom of said tube allows rod holder to be inserted deep into ground, encompassing part of the said tube. In soft ground or beach situations this makes the rod holder very secure in all situations, even when a fish is hooked on the line and even after prolonged fighting. Angled cut at top of said tube secures rod and reel, preventing swiveling, and allowing a person who has the use of only one arm to reel in the fish.

This application claims the benefit of Provisional Patent Application Ser. No. 60/184124, filed Feb. 22, 2000, referring specifically to Alternate Embodiment #2.

### BACKGROUND OF THE INVENTION

This invention pertains to a fishing rod holder, specifically designed to be used from the bank of a body of water, or coastal fishing from the surf.

### PRIOR ART REFERENCED INCLUDE:

U.S. Pat. No. 428,924 to Stuart Huber

U.S. Pat. No. 311,386 to Mary J. Beachel

U.S. Pat. No. 130,797 to Delmer M. Smelker

U.S. Pat. No. 536,325 to Gerry A. Butterwick, Sr.

U.S. Pat. No. 505,074 to Stanley C. Stockton

U.S. Pat. No. 399,647 to Michael D. Parker

In U.S. Pat. No. 428,924 to Stuart Huber, the assembly allows the Rod Holder to be folded for storage. In soft ground, beach or in big fish situations, the stability of the Rod Holder is questionable. The material is also subject to corrosion.

In U.S. Pat. No. 311,386 to Maruy J. Beachel, the fishing pole leans on an assembly and is not securely held by the Rod Holder. It could easily be pulled in the water by a fish. The adjustable assembly would make manufacturing expensive and also require maintenance.

In U.S. Pat. No. 130,797 to Delmer M. Smelker, the assembly allows for two fishing rods to be used, but it has to be held by the person fishing. Therefore, more than two rod and reels could not be used at the same time.

In U.S. Pat. No. 536,325 to Gerry A. Butterwick, Sr., the base and supports would be unstable during a fish strike, or in a big fish strike and run situation. The rod and reel, which is cradled in grooves, could be pulled into the water. Manufacturing this assembly would be very costly.

In U.S. Pat. No. 505,074 to Stanley C. Stockton, the assembly, being made of only a tubular material would not be appropriate to use in a hard ground situation. The hinge would require maintenance to prevent corrosion.

In U.S. Pat. No. 399,647 to Michael D. Parker, the assembly requires a support to be mounted onto, thus not allowing a person to fish from a bank of water or a coastline without a mountable surface.

### SUMMARY

My invention, FISHING ROD HOLDER FOR BANK AND COASTAL FISHING, is a one piece assembly, which inserts into the ground and securely holds a rod and reel for hands free fishing. The specific, critical novel features of my invention are:

a) Angled cut at the bottom of the tube allows the rod holder to be inserted deep into the ground, encompassing part of tube. In soft ground or beach situations this makes the rod holder very secure in all situations, even when a fish is hooked on the line and fighting;

b) Allows rod holder to be used in hard terrain because the rod extends to the top of the tube and is sturdy enough to be hammered into very hard ground, gravel, dry dirt, and even rocky terrain;

c) Inside diameter of the tube is of sufficient size to accommodate all rod handles, even pistol grip;

d) Long handled rods, such as salt water surf rods, can pass through rod holder since bottom does not have a stop;

e) Allows persons who have the use of only one arm to reel the fish in because the angled cut at the top of the rod holder holds the rod and reel securely without any swiveling.

Additional Advantages are:

a) Allows person to fish unlimited rods and reels at the same time;

b) Absolutely prevents rod and reel from being pulled into the water even if a fish is on the line for a prolonged period of time;

c) Provides a rod holder without moving parts, which makes it maintenance free and non-corrosive;

d) Keeps rod and reel off the ground so they will not be stepped on and broken;

e) Provides high visibility of rod and reel;

f) Keeps mud and salt off of the reel while baiting the hook, changing tackle, and removing fish;

g) Attractive color choice;

h) Simple design is cost effective to manufacture;

i) Rod holder can be inserted into pre-formed holes of truck bed rail;

j) Rod holder can be inserted into deck or dock between boards or by drilling ½ inch holes;

k) Rod holder can be used in boats by inserting into oar locks on the side;

l) Fish stringers and several hook throw lines can be anchored to rod holder;

m) Rod Holder is durable, one piece, lightweight, portable, and can be inserted at any angle desired;

n) Beverage holder can be added to Rod Holder by securing with tie wraps;

o) Quick access to rod and reel when fish strikes; and

p) Small diameter of rod allows easy insertion into ground.

### DESCRIPTION OF DRAWINGS

FIG. 1 is a side view of the rod holder before the tube is attached to the rod.

FIG. 2 is a rear view of the rod holder before the tube is attached to the rod.

FIG. 3 is a side view of the rod holder assembled.

FIG. 4 is a side view of a rod holder inserted into the bank. Rod and reel is in fishing position.

FIG. 5 is a side view of the rod holder inserted into beach. Part of tube is also inserted into sand for added security. Rod and reel is in fishing position.

FIG. 6 is a side view of the rod holder inserted between boards of a dock, or into half inch drilled hole. Rod and reel is in fishing position

FIG. 7 is a side view of the rod holder inserted into oarlocks on side of boat. Rod and reel is in fishing position.

FIG. 8 is a side view of the rod holder inserted into preformed holes in bed rail of truck. Rod and reel is in fishing position.

FIG. 9 is a side view of the rod holder with a beverage holder attached with plastic tie wraps.

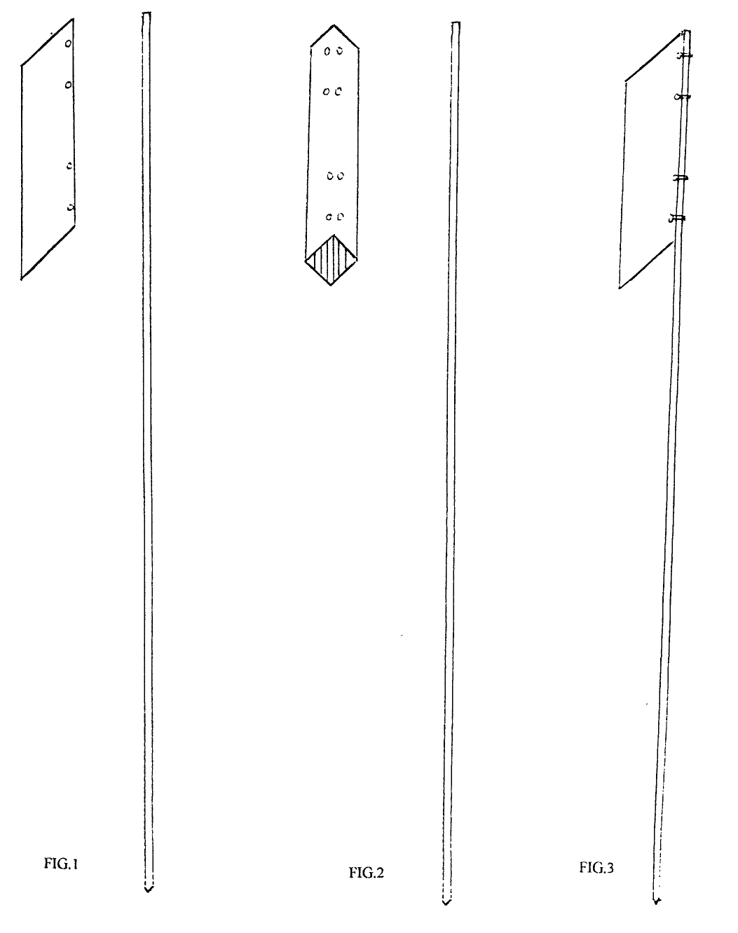

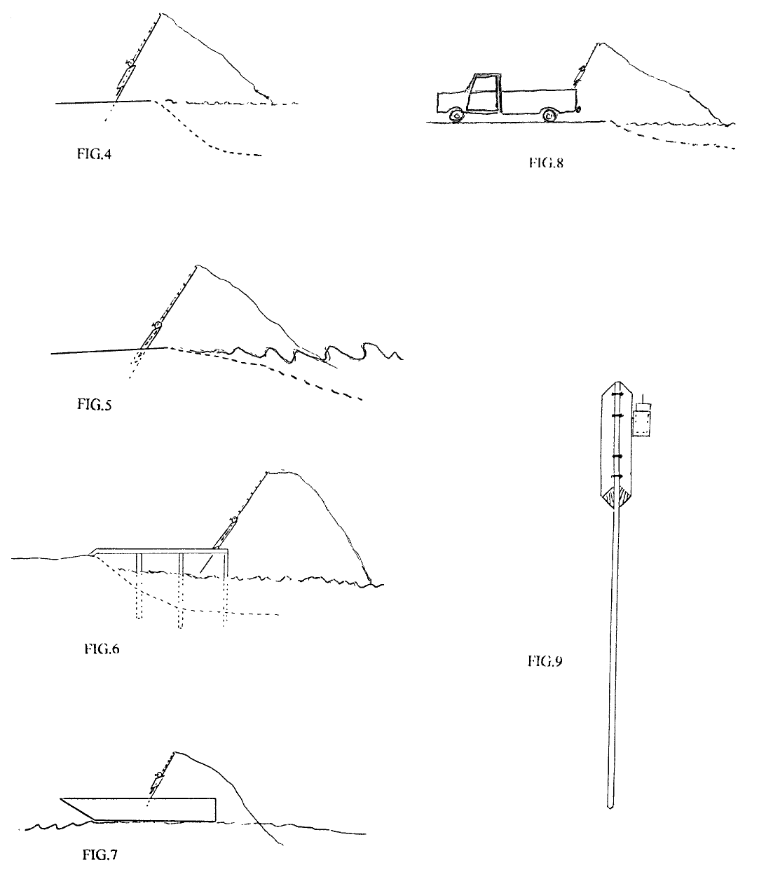

### DETAILED DESCRIPTION OF INVENTION

A rod, made of non corrosive metal or other rigid material, such as rebar, is approximately ⅜ inches in diameter and approximately 3-4 feet long and is pointed on one end and flat on the other end. A tube made of a rigid material, such as polyvinyl chloride, commonly called pvc, is approximately 15-21 inches with an inside diameter of approximately 2 inches The ends of the said tube are parallel at 45 degree angles. The said tube is attached to the said rod with plastic tie wraps and adhesive.

Cut the said tube 15 to 21 inches in length with 45 degree parallel ends. Drill 4-5 pairs of ¼ inch holes approximately 2 ½ inches apart on the spine of the said tube. Deburr sharp edges. The two holes of each pair are approximately ¼ inch apart on each side of the spine of the said tube. Paint as desired. Cut the said rod 3-4 feet in length. Grind top end flat and deburr and grind bottom end to a dull point. Prime and paint rod with rust resistant paint. Place the said rod on the spine of the said tube between the pre-drilled holes with the top flat end of the said rod flush with the top angle of the said tube. Insert plastic tie wraps through each pair of holes in the said tube and secure tightly around the said rod. Trim excess from tie wraps. Apply adhesive to both sides of the juncture of the said rod and the said tube.

Push the pointed end of the rod holder assembly into the bank or sand to the desired depth and at the desired angle. After casting, place the handle of the rod and reel into the said tube until reel contacts the angle of said tube. When strike occurs, simply lift rod and reel out of the rod holder, and land your fish.

The disclosure of the invention described herein above represents the preferred embodiments of the invention; however, variations thereof, in the form, size, construction, and arrangement of the various components thereof and the modified application of the invention are possible without departing from the spirit and scope of the invention.

1. I claim a fishing rod holder used to hold a rod and reel while fishing from a bank of water or from the coastline, comprising:
a) a rigid tube with ends cut at parallel angles and being of sufficient length and inside diameter to accommodate all rod handles,
b) a rigid rod being approximately two and a half times the length of said tube, having a small diameter with the top end flat and the bottom end pointed, and
c) means for joining the said rod to said tube with the highest point of the said tube flush with the top, flat end of the said rod.

2. In claim 1 said tube being made of polyvinyl chloride pipe-like material, commonly known as pvc, of approximately 2 inches inside diameter and having angles cut at approximately 45 degrees, having a length of approximately 15-21 inches.

3. In claim 1 said rod being of steel type, such as rebar, of approximately ⅜ inch diameter and being approximately 3 to 4 feet long.

4. In claim 1 said means for joining said rod to said tube, using plastic tie wraps which are inserted through a plurality of pairs of holes approximately ¼ inch in diameter along the spine of the said tube and then secured around the said rod and adhesive such as silicone 2 is applied at both sides of the juncture of the said rod and said tube.
